(19) United States
(12) Patent Application Publication
(10) Pub. No.: US 2026/0237530 A1
(43) Pub. Date: Aug. 13, 2026

(54) MATERIAL DELIVERY SYSTEM

(71) Applicant: Tokamak Energy Ltd, Milton, Abingdon, Oxfordshire (GB)

(72) Inventor: Kyaw SWAR, Milton, Abingdon (GB)

(21) Appl. No.: 19/153,874

(22) PCT Filed: Feb. 7, 2024
(86) PCT No.: PCT/EP2024/053007

§ 371 Date: Aug. 5, 2025

(30) Foreign Application Priority Data
Feb. 10, 2023 (GB) 2301924.3

(51) Int. Cl. G21B 1/11; B65B 37/02; B65B 39/00; B65B 43/50; G21B 1/05

(52) U.S. Cl. CPC G21B 1/11; B65B 37/02; B65B 39/001; B65B 43/50; G21B 1/05

(57) ABSTRACT

A material delivery system for a plasma system is disclosed. The delivery system includes a receptacle assembly including a plurality of receptacles and an aperture through which to deliver material to the plasma system, and a material feeder assembly for providing material to the receptacle assembly, wherein, the receptacle assembly is operable to move between a material delivery configuration in which the aperture is aligned with the material feeder assembly to allow passage of material through the receptacle assembly, and a plurality of material collection configurations in which a respective one of the receptacles obstructs passage of material through the receptacle assembly to allow collection of material by the receptacle.

This invention was made under CRADA No. NFE-19-07769 among Tokamak Energy Limited, UT-Battelle, LLC, management and operating contractor for Oak Ridge National Laboratory for United States Department of Energy, and The Trustees of Princeton University, management and operating contractor for the Princeton Plasma Physics Laboratory for the United States Department of Energy. The Government has certain rights in this invention.

### CROSS-REFERENCE TO RELATED APPLICATIONS

This application is the U.S. National Stage entry of International Application No. PCT/EP2024/053007, filed on Feb. 7, 2024, which, in turn, claims priority to GB Patent Application No. 2301924.3, filed on Feb. 10, 2023, both of which are hereby incorporated herein by reference in their entireties for all purposes.

### TECHNICAL FIELD

The present invention relates to material delivery system for a plasma system, and a method of operating the same.

### BACKGROUND

Impurity seeding is a process of injecting so-called “impurities”—either as a powder (e.g., <250 μm particles) or granules (e.g., >250 μm to a few mm particles)—into the plasma vessel of a magnetic confinement plasma system prior to and/or during plasma operation. Example impurities are Lithium, Boron, Boron Nitride, and Carbon. Impurity seeding advantageously allows real-time conditioning of both the plasma and the plasma vessel walls. For example, impurity seeding has been demonstrated to be effective at mitigating damage to the plasma vessel walls during disruption events, and promoting high-confinement plasma operating modes. Moreover, as plasma systems move towards longer pulse durations, real-time control of plasma vessel wall conditioning during pulses through impurity seeding will be needed as traditional methods, such as glow discharge cleaning, cannot be used, e.g., in a plasma system with a permanently active magnetic field.

A known powder dropper system 100 for a magnetic confinement plasma system is shown in FIGS. 1A and 1B. The powder dropper system comprises a primary powder reservoir 102; a secondary powder reservoir 104; a horizontal trough 106 to receive powder from the reservoirs 102, 104; a drop tube 108 through which the powder can pass into the plasma vessel (not shown); two piezo-electric actuators 110 operable to oscillate the trough 106 and secondary reservoir 104 to drive powder on the trough into the drop tube 108; and a powder diverter 112, comprising a lateral tube 112a extending from the drop tube, an arm 112b and a receptacle 112c. FIG. 1A shows the powder dropper system in an open configuration, whereby the arm 112b of the diverter does not impede passage 114 of the powder through the drop tube into the plasma vessel. FIG. 1B shows the powder dropper system 100 in a closed configuration, whereby the arm 112b of the diverter has been moved into the drop tube to divert passage 116 of the powder to the receptacle for waste disposal.

The powder dropper system 100 shown in FIGS. 1A and 1B has a single set of powder reservoirs 102, 104, and is only configured to drop a single type of powder source. Other known systems, however, are able to drop up to four different types of powder in total by having additional powder reservoirs 102, 104, troughs 106 and piezo-electric actuators 110 for each additional powder type.

Plasma is, however, highly sensitive to these injected impurities. For example, it is reported in “Initial results from boron powder injection experiments in WEST lower single null L-mode plasmas”, Bodner et al., published in HAL open science 15 Jun. 2022 that mass injection rates of boron powder greater than ~17 mg/s can lead to disruptions (i.e., instabilities) in the plasma. Appropriate calibration and commissioning of powder dropper systems is therefore important.

Calibrating each set of piezoelectric actuators 110 in the powder dropper system 100 comprises determining the relational dependence between the mass flow rate at which powder is dropped, and the sinusoidal voltage profile to energize that set of actuators. The mass flow rate can be, for example, determined using an optical flow meter, as is known to the skilled reader. A method to calibrate the powder dropper system is described in, for example, section V of “A Multi-Species Powder Dropper for Magnetic Fusion Applications”, Nagy et al., 16 May 2018.

During calibration and/or commissioning of the powder dropper system 100, it is, of course, important that powder does not enter the plasma vessel. For this reason, existing systems, as shown in FIGS. 1A and 1B, include a powder diverter 112 to divert flow of the powder from the drop tube 108 into a receptacle 112c.

One problem with existing systems is that powders of different type (e.g., particle size, material) end up being mixed together in the receptacle 112c. These mixed powder types cannot be easily separated, and are often discarded, which is wasteful and costly. For example, mixed powders containing lithium require careful handling and disposal because lithium powder reacts with ambient moisture.

An improved powder dropper system for a magnetic confinement plasma system is desirable.

### SUMMARY

According to a first aspect of the present invention, there is provided a material delivery system for a plasma system. The material delivery system comprises a receptacle assembly having a plurality of receptacles and an aperture through which to deliver material to the plasma system, and further comprises a material feeder assembly for providing material to the receptacle assembly. The receptacle assembly is operable to move between a material delivery configuration in which the aperture is aligned with the material feeder assembly to allow passage of the material through the receptacle assembly, and a plurality of material collection configurations in which a respective one of the receptacles obstructs passage of the material through the receptacle assembly to allow collection of material by that receptacle. This system advantageously allows for collection of different forms of a material (e.g., different powder size range, shape etc.) in different receptacles so that mixing of different material forms can be avoided. The system also advantageously allows for a greater amount of material to be collected compared to systems that have only one receptacle.

Optionally, the material feeder assembly comprises a material selection mechanism for selectively providing one or more of a plurality of different materials to the receptacle assembly. The materials may be different from one another physically and/or chemically. For example, the different materials may have the same or substantially the same chemical composition, but have particles that differ in size or shape, or have different physical states (e.g. the material(s) may be provided in liquid form in some cases). Alternatively, or in addition, the different materials may have different chemical compositions from one another, e.g. the different materials may each be a respective one of powdered or granulated lithium, boron and carbon. Such a system can then collect different materials in different receptacles so that mixing of different materials can be, at least to some extent, avoided. Separate collection of the different materials can lead to significant cost reductions. In a specific example, a first receptacle is used for collecting lithium, a second receptacle is used for collecting carbon, and a third receptacle is used for collecting boron. For that specific example, the steps required to extract lithium from a mixed powder can be avoided, without loss of lithium.

Preferably, although not necessarily, the number of receptacles in the receptacle assembly is equal to, or greater than, the number of different materials that the material feeder assembly is able (e.g. configured) to provide, e.g. there may be a one-to-one correspondence between the different materials that can be provided and the receptacles. This ensures that there is at least one receptacle for each different material so that mixing of different materials can be avoided.

The material delivery system may also include a controller configured to control the configuration of the receptacle assembly in dependence on the material for which it is determined that the material feeder assembly next requires calibration and/or commissioning. For example, if the material feeder assembly next requires calibration for a material “A”, then the controller is configured to modify the configuration of the receptacle assembly to a corresponding configuration “A”. If, subsequently, the material feeder assembly requires calibration for a material “B”, then the controller is configured to modify the configuration of the receptacle to a corresponding configuration “B”. In this way, the system provides the required functionality to collect the different materials “A” and “B” in separate receptacles, thereby avoiding mixing. As noted above, material “A” and material “B” may differ in their physical and/or chemical properties.

In some implementations, the receptacle assembly may be operable to move the aperture and the receptacles simultaneously. For example, the aperture may be provided in a mount that supports the receptacles (e.g. a plate having a plurality of apertures in which the receptacles are provided, with at least one of the apertures not having a receptacle). The receptacle assembly may then be operable to move the mount (e.g. rotate the plate) to obtain each of the material delivery and material collection configurations.

Optionally, the plurality of receptacles and the aperture are arranged collinearly with respect to one another.

Alternatively, the plurality of receptacles and the aperture are arranged circumferentially with respect to one another (i.e. spaced apart from one another around a perimeter of a circle or polygon). This arrangement may be more compact than the linear arrangement, saving space in the material delivery system (at least in one direction).

The material delivery system may comprise one or more linear actuators operable to move each receptacle along a linear path. For example, between a first position in which the respective receptacle is positioned to collect material that passes into the receptacle assembly, and a second position in which the respective receptacle allows passage of material through the receptacle assembly.

The material delivery system may alternatively comprise one or more rotary actuators operable to move each receptacle along a curved path. For example, between a first position in which the respective receptacle is positioned to collect material that passes into the receptacle assembly, and a second position in which the respective receptacle allows passage of material through the receptacle assembly.

The or each linear or rotary actuator may be pneumatic or hydraulic, i.e. configured to operate pneumatically or hydraulically. Pneumatics and hydraulics are not affected by the high magnetic fields present in some plasma systems. Conversely, the normal operation of other types of actuators, e.g., electromagnetic actuators, can be adversely affected by those fields. Advantageously therefore, pneumatically or hydraulically operated actuators provide improved control over the system.

Optionally, the material delivery system includes a tubular assembly, having a first tubular extending from the material feeder assembly to the receptacle assembly and a second tubular extending away from the receptacle assembly, through which material may pass. An end portion of the second tubular, which is distal from the material feeder assembly, may be configured to couple with a vessel wall of a plasma system. The tubular assembly may facilitate coupling between the material delivery system and the plasma system so that material can be delivered from the material feeder assembly into the plasma system.

The material feeder assembly may be arranged relative to the receptacle assembly so that, in use, material provided by the feeder assembly passes into the receptacle assembly by means of gravity. Advantageously, a mechanism for propelling the material (against gravity) is not required, saving on energy costs, and simplifying the design of the system. The material feeder assembly could then be a conventional dropper system, as for example shown in FIG. 1.

The material may comprise any one or more of powdered or granulated: lithium, boron, boron nitride, and carbon. The use of other powdered or granulated elements, with low atomic number (e.g., Z<20), is possible. Powders may comprise particles having a mean diameter (or other characteristic maximum dimension) <250 μm. Granules may have a mean diameter (or other characteristic maximum dimension) between 250 μm to a 5 mm. Each set of powdered or granulated lithium, boron or carbon may, in turn, include powders/granules of different physical characteristics. For example, of different size, size distribution (i.e., mean size and standard deviation) and/or shape (e.g., spherical, cuboidal etc.).

The material delivery system may further comprise a material flow-meter for use in calibrating the material feeder assembly. The material flow-meter is positioned relative to the material feeder assembly and receptacle assembly so that it can measure a flow rate (e.g., a mass flow rate) of material being provided to the receptacle assembly.

In a specific example, the material flow-meter comprises: (i) a calibrated LED or other light-emitting device configured to emit a collimated beam of light along a path that traverses the flow of material into the receptacle assembly; and (ii) a detector arranged to measure the light intensity of the collimated beam of light reaching the detector. When material is provided to the receptacle assembly, particles of the material being provided occlude the collimated beam, and the measured light intensity reduces. By monitoring this variation of light intensity, the flow rate (e.g., mass flow rate) and total mass of material being provided to the receptacle assembly can be calculated in a known way. During calibration, one of the plurality of receptacles can be positioned to collect the material that passes into the receptacle assembly so that material does not reach the plasma system. This avoids injecting uncontrolled (e.g. excessive) or imprecise amounts of material into the plasma system.

The calibration process itself comprises measuring the material flow rate using the material flow-meter, and adjusting the control parameters for the material feeder assembly conditional on the measured flow rate. For example, by adjusting the amplitude and/or frequency of the sinusoidal potential for the piezo-electric actuators 110 until the desired material flow rate (e.g., 10 mg/second is achieved. Those control parameters can then be used to accurately provide a desired amount of material. For example, 10 mg can be delivered by the material feeder assembly by operating the material feeder assembly using those determined control parameters for a period of 1 second.

According to a second aspect of the present invention, there is provided a plasma system comprising the material delivery system described above in connection with the first aspect.

According to a third aspect of the present invention, there is provided a method of operating a material delivery system installed in a plasma system. The material delivery system comprises: a plurality of receptacles, and a material feeder assembly for providing material to the plasma system. The material delivery system may also be as described in connection with the first aspect. The method comprises selecting a first receptacle from the plurality of receptacles, and moving the first receptacle into a position to allow material provided by the material feeder assembly to be collected in the first receptacle. Advantageously, operation of the material delivery system allows for the collection of material in different receptacles.

The method may further comprise selecting a first material from a plurality of different materials to be provided to the plasma system by the material feeder assembly, and collecting the first material in the first receptacle. Advantageously, operation of the material delivery system enables selective collection of different materials in different receptacles. For example, receptacle “A” can be used to collect material “A”; receptacle “B” can be used to collect material “B”; receptacle “C” can be used to collect a mixture of material “C” etc.

Optionally, the method is performed during calibration and/or commissioning of the material feeder assembly for the first material and/or other materials that can be provided by the material feeder assembly. The calibration process has been described above in connection with the first aspect and is not repeated here in full. It is sufficient to say that the calibration process includes: (i) measuring a material flow rate whilst the receptacle is in the position; and (ii) adjusting control parameters for the material feeder assembly conditional on the measured material flow rate. The commissioning process for the material feeder assembly is performed in substantially the same way.

The calibration process may be repeated for one or more further materials. For example, following completion of calibration and/or commissioning for the first material, a second receptacle from the plurality of receptacles may be selected and moved into a position in which second material from the material feeder assembly can be collected. The first receptacle is moved away from its material collection position to allow space for the second receptacle. The material feeder assembly may then select to provide the second material from the plurality of different materials to the plasma system, and collecting that material in the second receptacle.

Optionally, the material delivery system further comprises an aperture and following completion of calibration and/or commissioning for the first and/or second material, the method further comprises: moving the aperture into a position to allow passage of material provided by the material feeder assembly into a plasma chamber of the plasma system; and operating the material feeder assembly to inject the first and/or second material into the plasma chamber.

In some cases, the receptacle assembly may be provided (e.g. sold) separately from the material feeder assembly. For example, there may be provided a receptacle assembly for use in a material delivery system of a plasma system, the receptacle assembly comprising a plurality of receptacles and an aperture through which material can pass. The receptacle assembly is operable to move between a material delivery configuration in which the aperture is arranged to allow passage of material through the receptacle assembly, and a plurality of material collection configurations in which a respective one of the receptacles obstructs passage of material through the receptacle assembly to allow collection of material by that receptacle. Further details of the receptacle assembly have been described above in connection with the first aspect, and are not repeated here for conciseness.

### BRIEF DESCRIPTION OF THE DRAWINGS

FIGS. 1A and 1B are known powder dropper systems;

FIGS. 2A and 2B are cross sectional views of an example receptacle assembly;

FIG. 3 is a schematic illustration of a plan view of the receptacle assembly;

FIG. 4 is a method flow diagram; and

FIG. 5 is a cross sectional view of an example receptacle.

### DETAILED DESCRIPTION

The present disclosure proposes a material delivery system for a plasma system. In use, the delivery system delivers material into a plasma of, or confined by, the plasma system. The delivery system includes a receptacle assembly having a plurality of receptacles and an aperture through which to deliver material to the plasma system, and a material feeder assembly for providing material to the receptacle assembly.

The material feeder assembly may be able to provide one or more of a plurality of different materials to the plasma system. Materials can be categorised as different according to their physical properties and/or their chemical properties. Two materials are in different categories (i.e., are different) if they differ (substantially) in any one of these properties. For example, two materials with the same chemical composition may be different if they have different physical form. For example, if one of those materials is liquid and the other solid, if the materials are allotropic (e.g. different carbon allotropes), or if the materials have particles of different size, shape etc.

Example materials include elemental (i.e., >99% purity) powders or granules of lithium, boron, boron nitride, or carbon, or alloys thereof. Other example materials include other powdered or granulated elements with low atomic number elements (e.g., Z<20) and alloys thereof.

The proposed receptacle assembly is able to move between various different configurations. For example, from a material delivery configuration in which the aperture is aligned with the material feeder assembly to allow passage of the material through the receptacle assembly, and further material collection configurations in which different receptacles obstruct passage of the material through the receptacle assembly. As each receptacle is able to receive material when positioned to obstruct passage of the material, the proposed material delivery system is able to collect different materials using different receptacles. Advantageously therefore, the proposed material delivery system is able to at least mitigate the problem of different material mixing.

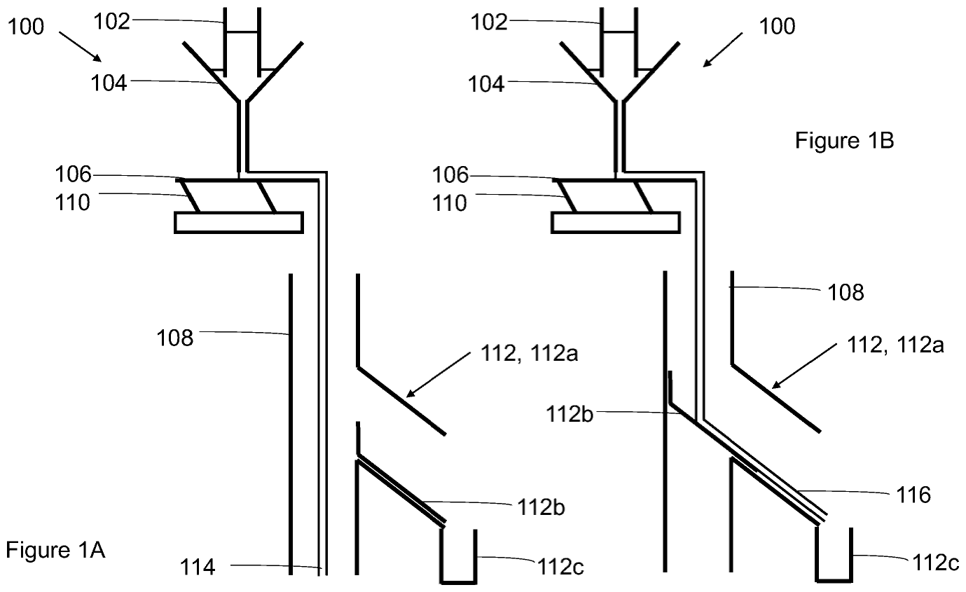

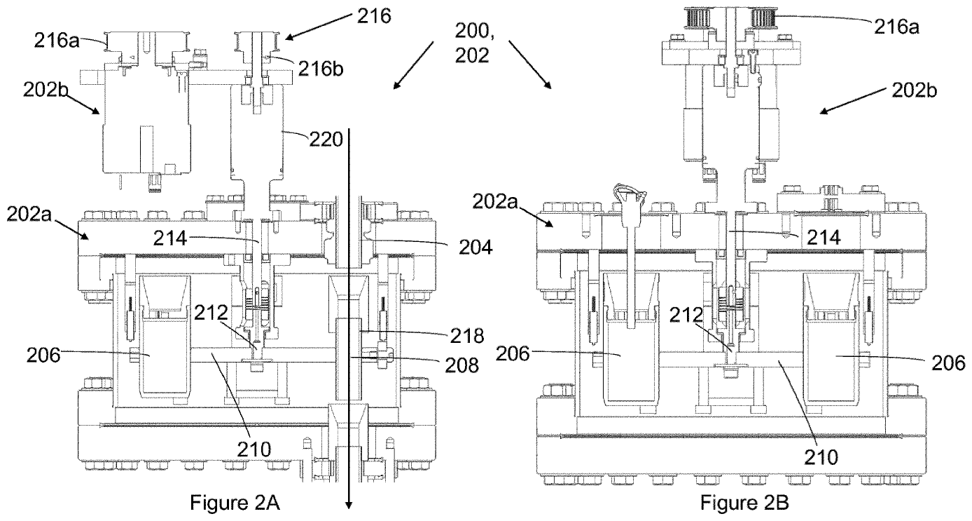

FIG. 2A and FIG. 2B show cross sectional views of a material delivery system 200. The material delivery system 200 includes a receptacle assembly 202, and a material feeder assembly (not shown). An example material feeder assembly that can be used with this receptacle assembly 202 is the powder dropper system 100 from FIG. 1, which is able to provide a plurality of different materials to the receptacle assembly 202. Other known material feeder assemblies can however substitute that system according to the operational needs of the plasma system.

The receptacle assembly 202 comprises a plurality of receptacles 206 and an aperture 208 arranged circumferentially on a mount 210. The receptacles 206 are secured to the mount using suitable mechanical fasteners, such as shoulder screws. Other types of mechanical fastener may however be used. The mount is mechanically coupled via a rotary bearing 212 to a shaft 214, which in turn, is mechanically coupled with a rotary actuator arrangement 216 for providing rotary motive force to the mount.

The rotary actuator arrangement 216 includes a stepper motor 216a and a belt drive 216b for amplifying the rotary speed of the stepper motor 216a. The rotary stepper motor 216a is operable to move each of the receptacles 206 along a curved path (e.g., along an arc on a mount 210). The shaft 214 is located centrically relative to the receptacles so that, upon actuation of the stepper motor 216a, the mount 210 and hence the receptacles 206 and aperture 208 are caused to rotate about the axis defined by shaft 214. In the example shown, a through-funnel 218 is provided in the aperture 208, although this is not essential.

The material delivery system 200 further comprises a tubular assembly 204 through which material is able to pass from the material feeder assembly 202 to the plasma system (not shown). The direction of the material is denoted by the arrow in FIG. 2A. The tubular assembly includes a first tubular that extends from the material feeder assembly to the plasma system and a second tubular that extends away from the receptacle assembly 202 to the plasma system (not shown). The receptacle assembly 202 is therefore able to selectively allow or prevent passage of material from the material feeder assembly to the plasma system by appropriate placement of the receptacles and the aperture 208 (and funnel 218). The end portion of the second tubular closest to the plasma system is provided with a coupling mechanism for attaching or otherwise securing the tubular to a vessel wall of the plasma system.

The material delivery system 200 further comprises a controller (not shown) to control the configuration of the receptacle assembly via the rotary actuator arrangement 216 so that any particular one of the receptacles 206 can be positioned to obstruct material being passed from the material feeder assembly to the plasma system. The configuration of the receptacle assembly can be controlled in dependence on the material for which it is determined that the material feeder assembly next requires calibration. Limit switches are used so that the controller is able to determine the current configuration of the receptacle assembly, although other ways of determining the current configuration of the receptacle assembly may be used.

For example, if the material feeder assembly next requires calibration for a material of type or form “A”, then the controller modifies the configuration of the receptacle assembly to a corresponding configuration “A”. In configuration “A”, receptacle “A” is moved into a position so that it can collect material provided from the material feeder assembly during that calibration procedure. If, subsequently, the material feeder assembly requires calibration for a material of type or form “B”, then the controller modifies the configuration of the receptacle assembly to a corresponding configuration “B”. In configuration “B”, receptacle “B” (different to receptacle “A”) is moved into a position in which it can collect material provided from the material feeder assembly during that calibration procedure. As receptacle “B” is moved into that position, receptacle “A” is moved away from its collection position. After the material feeder assembly is properly calibrated, the controller can modify the configuration of the receptacle assembly such that the aperture 208 and funnel 218 are positioned to allow material to pass through the receptacle assembly and into the plasma system. In this way, the material delivery system has the required functionality to: (i) collect material “A” and material “B” in separate receptacles to avoid material mixing, e.g., during calibration, and (ii) deliver material to the plasma system, e.g., following calibration.

When in use with a plasma system, the interior of the receptacle assembly 202, comprising a lower portion 202a and upper portion 202b may be under partial vacuum, whereas the stepper motor 216a is under a higher pressure, for example, ambient pressure. Therefore, to facilitate rotation of the mount 210, a bellows-sealed rotary feedthrough 220 is used to connect the stepper motor 216a to the mount 210. The receptacle assembly may further comprise an electrical feedthrough (not shown) for the limit switch cables (not shown).

In the example shown, the stepper motor 216a is a pneumatic stepper motor. A hydraulic stepper motor is a suitable alternative. Pneumatically or hydraulically operated actuators are not affected by magnetic fields, whilst electromagnetic actuators may be susceptible to interference issues in magnetic fields greater than 0.03 T, without magnetic shielding. The magnetic field strength in typical plasma systems far exceeds this value. A pneumatic or hydraulic stepper motor may therefore provide improved control and stability compared to other stepper motors. In a specific example, the pneumatic stepper motor is configured to rotate by 3 degrees per valve actuation, and the belt drive 216b multiples the rotary speed by a factor of 3. More generally, the angle of rotation per valve actuation, and the speed multiplication factor of the belt drive may vary for different implementations depending on the required step size and rotation speed. Optionally, a belt tensioning block (not shown) can be provided to assist the belt drive.

In the example shown, the rotary bearing 212 is made from a ceramic (e.g., ZrO₂) and has a retainer made from PEEK (or any other vacuum-compatible polymer known to the skilled reader). However, other rotary bearings comprising different materials can be used.

The material delivery system may further comprise a material flow-meter (not shown) for use in calibrating the material feeder assembly. The material flow-meter is positioned relative to the material feeder assembly and receptacle assembly so that it can measure a flow rate (e.g., a mass flow rate) of material being provided to the receptacle assembly. The material flow-meter may be an optical flow-meter in some implementations. In a specific example, the material flow-meter comprises: (i) a calibrated LED or other light-emitting device configured to emit a (preferably collimated) beam of light along a path that traverses the flow of material into the receptacle assembly; and (ii) a detector arranged to measure the light intensity of the beam of light reaching the detector. When material is provided through to the receptacle assembly, the material being provided occludes the beam, and the measured light intensity reduces. By monitoring this variation of light intensity, the flow rate (e.g., mass flow rate) and total mass of material being provided to the receptacle assembly can be calculated in a known way.

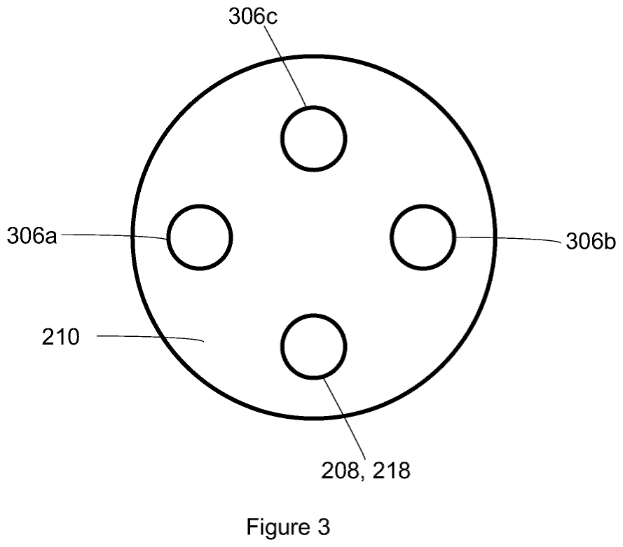

FIG. 3 is a schematic illustration of the plan-view of the receptacle assembly 202 from FIGS. 2A and 2B. As shown, the mount 210 of the receptacle assembly 202 comprises three receptacles 306a, 306b, 306c, and an aperture 208 in which a through-funnel 218 is provided. The specific receptacle assembly shown is adapted for use with a material feeder assembly that is able to provide two or three different materials. For example, powdered lithium and carbon and/or boron.

In the specific example shown, the first receptacle 306a is provided for receiving a first material from the feeder assembly, a second receptacle 306b is provided for receiving a second material from the feeder, which is different to the first material. The third receptacle 306c is provided for receiving either or both the first and second materials from the feeder, e.g. when the feeder assembly is operated to provide a mixture of the first and second material simultaneously. The controller described above then controls the configuration of the receptacle assembly to ensure that the corresponding receptacle is moved into position to collect its corresponding material(s) (e.g., during calibration). More generally, the number of receptacles in the receptacle assembly may be equal to or greater than the number of different materials that the material feeder is able to provide (i.e. provide separately), as this ensures that a separate receptacle is provided for each different material.

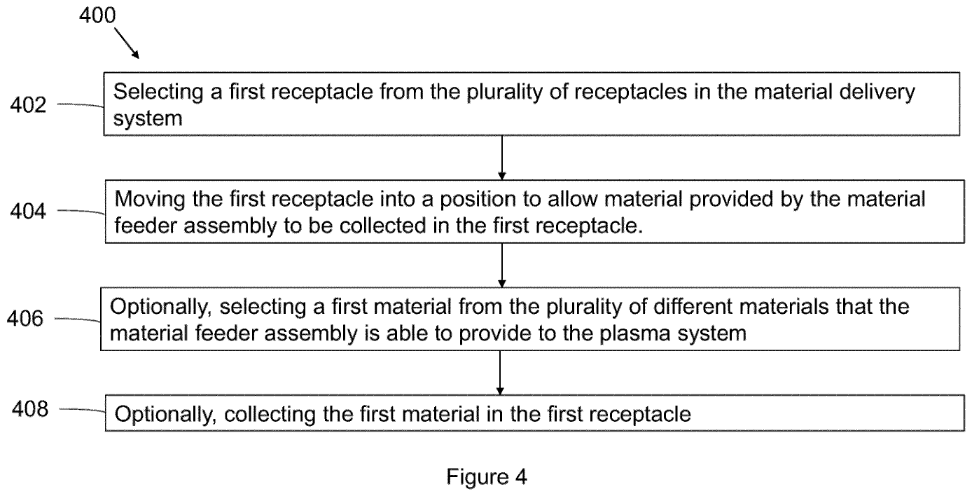

Operation of the material delivery system shown in FIGS. 2A, 2B and 3 is now described with reference to the method flow diagram 400 shown in FIG. 4.

In step 402, a first receptacle is selected from the plurality of receptacles in the material delivery system, e.g. during calibration of the material delivery system.

In step 404, the first receptacle is moved into a position to allow material provided by the material feeder assembly to be collected in the first receptacle.

Optionally, in step 406, a first material is selected from the plurality of different materials that the material feeder assembly is able to provide to the plasma system.

Optionally, in step 408, the first material is collected in the first receptacle.

Optionally, in step 410 (not shown), the first receptacle is moved away from its collection position and the aperture of the receptacle assembly is moved into a position to allow material provided by the material feeder assembly to pass into the plasma system.

The method of FIG. 4 is performed during calibration and/or commissioning of the material feeder assembly. The calibration/commissioning (which are referred to interchangeably herein) can be performed for any one or combination of the plurality of different materials that the material feeder assembly is able to provide. For example, referring specifically to the system described in relation to FIG. 3, a first material only, a second material only, or a mixture of the first and second materials according to any volume fraction or mass fraction ratio. The skilled reader will appreciate that the material for which the material feeder assembly is to be calibrated depends on the operational needs of the plasma system, and in particular its plasma.

During calibration, one of the plurality of receptacles is positioned to collect material passing into the receptacle assembly to prevent that material reaching the plasma system. The injection of an uncontrolled or imprecise amount of material into the plasma system can therefore be avoided.

Calibration comprises measuring the material flow rate using the material flow-meter whilst a receptacle is in a collection position. The control parameters for the material feeder assembly may be adjusted conditional on the measured material flow rate. In a specific example, by adjusting the amplitude and/or frequency of the sinusoidal potential for the piezo-electric actuators is adjusted until the desired material flow rate (e.g., 10 mg/second) is achieved, and those control parameters can then be used to accurately provide a desired amount of material. For example, 10 mg can be delivered by the material feeder assembly by operating the material feeder assembly using those determined control parameters for a period of 1 second.

Steps 402 to 408 may then be repeated for any other one or combination of the plurality of different materials that the material feeder assembly is able to provide, until calibration for each different material has been carried out, or until such time that the material delivery system is required to deliver a respective one of those materials to the plasma system. Steps 402 to 408 may also be repeated for the same material if recalibration is required.

The ordering of the method steps as presented in FIG. 4 is not intended to be limiting. For example, step 406 may be performed prior to steps 402 and/or step 404. When steps 402 to 408 are repeated for different materials and/or receptacles, step 410 may be performed in the process of moving the first receptacle away from its collection position.

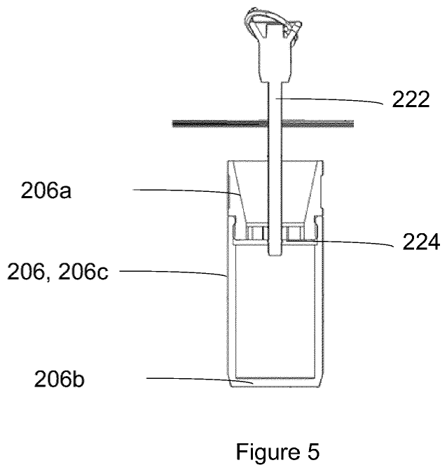

FIG. 5 shows a close-up cross sectional view of a receptacle 206 from the material delivery system 200 shown in FIGS. 2A and 2B.

As shown, the receptacle 206 defines a cap portion 206a, having a tapered inner surface, a base portion 206b and a sidewall portion 206c extending between the cap and base portions 206a, 206b. The interior volume defined by these portions is suitable for receiving material. In a specific example, the interior volume for the receptacle 206 is 80 cm³. Larger or smaller volumes for the receptacle are also possible.

In FIG. 5, a removable pin 222 for removing the receptacle 206 from the lower portion 202a to the upper portion 202b of the receptacle assembly is shown. The pin 222 includes a latching arrangement 224 at one end for engaging with the tapered inner surface of the cap portion 206a for this purpose. The opposing end is provided with a grip so that an operator may easily remove the receptacle. In a specific example, the pin 222 is a detent pin but other mechanisms for removing the receptacles are possible. In this way, receptacles 206 filled with material can be removed following pressurisation of the receptacle assembly 202 to ambient pressure. To maintain cleanliness inside the assembly 202 between replacing receptacles 206, the assembly 202 can be backfilled with dry nitrogen gas. Once pressurised, the receptacle 206 can be easily removed (e.g., by hand or using a robotic operator), emptied and replaced back into the receptacle assembly.

Although the specific material delivery system described above provides powdered lithium, carbon and/or boron, it is suitable for providing other and further materials. For example, other elemental (i.e., >99% purity) powders or granules with low atomic number elements (e.g., Z<20) and alloys thereof (e.g., boron nitride).

Various modifications are possible within the scope of the invention, as will be clear to the skilled reader. At least the following variants are possible.

The receptacle assembly may have a plurality of apertures 208 so that the angle of rotation required to move an aperture 208 (including, optionally, a funnel 218) into a position collinear with tubular 204 is reduced.

The number of receptacles may be greater than three, for example, there may be four, five, six, seven, eight, nine or ten receptacles.

One or more further of these receptacle assemblies 202 may be stacked on top of one another so that material passes through a plurality of receptacle assemblies 202 before entering the plasma system. The tubular assembly 204 may then include additional tubulars extending between adjacent receptacle assemblies 202 in the stack, in addition to the first tubular that extends from the material feeder assembly to the plasma system and the second tubular that extends away from the receptacle assembly 202 to the plasma system.

The plurality of receptacles and the aperture may be arranged collinearly with respect to one another (as opposed to circumferentially) and substantially orthogonal to the longitudinal axis defined by tubular assembly 204. The rotary actuator arrangement 216 in FIG. 2 is then replaced with one or more linear actuators. The one or more linear actuators are able to move each receptacle along a linear path between a position in which that receptacle obstructs passage of the material through the receptacle assembly and a position in which passage of the material through the receptacle assembly is left unaffected by that receptacle. Such a linear actuator can be provided for each receptacle, so that each can be linearly actuated independently of the other receptacles. Alternatively, the linear actuator may act on the receptacles collectively so that receptacles are linearly actuated together, e.g. the linear actuator may act on the mount supporting the receptacles.

The plurality of receptacles may be arranged circumferentially with the aperture being arranged centrically relative to those receptacles. The rotary actuator arrangement 216 in FIG. 2 is then replaced with a plurality of linear actuators, with each actuator being configured to move a respective receptacle to and from a circumferential and a central position. The central position corresponds to the receptacle being co-located with the aperture so that material passing into the receptacle assembly is collected by the receptacle, as opposed to passing through the aperture into the plasma system.

The one or more linear actuators may also be operated pneumatically or hydraulically.

In some examples (e.g., where a plurality of linear actuators is used), the aperture of the receptacle assembly does not move as the receptacle assembly 202 changes configuration. Instead, to obstruct passage of material through the receptacle assembly, one of the receptacles is moved into a position that obstructs passage of the material through the aperture (i.e., immediately upstream).

The material feeder assembly for the material delivery system in FIGS. 2A and 2B may be a dropper type system, whereby material is provided by the feeder assembly through to the plasma system by means of gravity. Alternatively, the material feeder assembly may include a mechanism for propelling material through to the plasma system such that the system can be arranged at any given orientation.

The material delivery system and variants thereof described above may form part of a plasma system, including a magnetic confinement chamber (or plasma vessel). The plasma system may comprise or be part of any suitable device for confining a plasma such as a tokamak or a stellarator.

1. A material delivery system for delivering a powdered or granulated or liquid material to a plasma system, the material delivery system comprising:
a receptacle assembly comprising a plurality of receptacles and an aperture through which to deliver material to the plasma system; and
a material feeder assembly for providing the powdered or granulated or liquid material to the receptacle assembly,
wherein, the receptacle assembly is operable to move between a material delivery configuration in which the aperture is aligned with the material feeder assembly to allow passage of material through the receptacle assembly, and a plurality of material collection configurations in which a respective one of the plurality of receptacles obstructs passage of material through the receptacle assembly to allow collection of material by the receptacle.

2. The material delivery system according to claim 1, wherein the material feeder assembly comprises a material selection mechanism for selectively providing one or more of a plurality of different materials to the receptacle assembly.

3. The material delivery system according to claim 2, wherein a number of receptacles in the receptacle assembly is equal to, or greater than, a number of different materials that the material feeder assembly is able to provide.

4. The material delivery system according to claim 2, further comprising a controller configured to control the configuration of the receptacle assembly in dependence on the material for which it is determined that the material feeder assembly next requires calibration or commissioning.

5. The material delivery system according to claim 1, wherein the plurality of receptacles and the aperture are arranged collinearly with respect to one another.

6. The material delivery system according to claim 1, wherein the plurality of receptacles and the aperture are arranged circumferentially with respect to one another.

7. The material delivery system according to claim 1, further comprising one or more linear actuators operable to move each receptacle along a linear path.

8. The material delivery system according claim 6, further comprising one or more rotary actuators operable to move each receptacle along a curved path.

9. (canceled)

10. The material delivery system according to claim 1, further comprising a tubular assembly, having a first tubular extending from the material feeder assembly to the receptacle assembly and a second tubular extending away from the receptacle assembly, through which material may pass.

11. (canceled)

12. The material delivery system according to claim 1, wherein the material feeder assembly is arranged relative to the receptacle assembly so that material provided by the feeder assembly passes into the receptacle assembly by means of gravity.

13. (canceled)

14. The material delivery system according to claim 1, further comprising a material flow-meter for use in calibrating the material feeder assembly.

15. A plasma system comprising the material delivery system according to claim 1.

16. A method of operating a material delivery system installed in a plasma system, the material delivery system comprising: a plurality of receptacles, and a material feeder assembly for providing a powdered or granulated or liquid material to the plasma system, the method comprising:
selecting a first receptacle from the plurality of receptacles; and
moving the first receptacle into a position to allow the powdered or granulated or liquid material provided by the material feeder assembly to be collected in the first receptacle.

17. The method according to claim 16, further comprising:
selecting a first material from a plurality of different materials to be provided to the plasma system by the material feeder assembly; and
collecting the first material in the first receptacle.

18. The method according to claim 17, in which the method is performed during calibration or commissioning of the material feeder assembly for the first material.

19. The method according to claim 16, wherein calibration of the material feeder assembly comprises measuring a material flow rate whilst the first receptacle is in the position and further comprises adjusting control parameters for the material feeder assembly conditional on the measured material flow rate.

20. (canceled)

21. The method according to claim 18, wherein, following completion of calibration or commissioning for the first material, the method further comprises:
selecting a second receptacle from a plurality of receptacles;
moving the first receptacle away from its material collection position; and
moving the second receptacle into a position in which a second material from the material feeder assembly can be collected.

22. The method according to claim 21, further comprising:
operating the material feeder assembly to provide the second material from a plurality of different materials to the plasma system; and
collecting the second material in the second receptacle.

23. The method according to claim 21, wherein the material delivery system further comprises an aperture and following completion of calibration or commissioning for the first material or the second material, the method further comprises:
moving the aperture into a position to allow passage of material provided by the material feeder assembly into a plasma chamber of the plasma system; and
operating the material feeder assembly to inject the first material or the second material into the plasma chamber.
